(19) United States
(12) Patent Application Publication
(10) Pub. No.: US 2026/0216853 A1
(43) Pub. Date: Jul. 30, 2026

(54) Electric hand tool with an accumulator unit detachably fastened to the machine housing

(71) Applicant: Hilti Aktiengesellschaft, Schaan (LI)

(72) Inventors: Daniel SELTMANN, Türkheim (DE); Michael UNSÖLD, Penzing (DE)

(21) Appl. No.: 19/141,687

(22) PCT Filed: Dec. 6, 2023
(86) PCT No.: PCT/EP2023/084449

§ 371 Date: Jun. 20, 2025

(30) Foreign Application Priority Data
Jan. 12, 2023 (EP) 23151373.0

(51) Int. Cl. B25D 17/04; B25F 5/02

(52) U.S. Cl. CPC B25D 17/04; B25F 5/02; B25D 2250/091; B25D 2250/121; B25D 2250/245

(57) ABSTRACT

An electric hand tool, in particular an impact hammer, with a tool receiving unit (1) for a tool arranged along an impact axis (X), a drive unit for the tool subsequently accommodated in a machine housing (2) and a handle (3) arranged opposite the tool receiving unit (1) on the machine housing (2), wherein at least one accumulator unit (8a; 8b) detachably fastened to the machine housing (2) is provided for the electrical power supply, wherein at least one housing recess (7a; 7b) extending transversely to the impact axis (X) is provided in the region of the machine housing (2) for the exchangeable accommodation of the accumulator unit (8a; 8b), in which the accumulator unit (8a; 8b) is arranged in such a way that the overall center of gravity with respect to the impact axis (X) in the radial direction lies within the lateral dimension of the drive unit.

The present invention relates to an electric hand tool, in particular an impact hammer.

### BACKGROUND

The field of application of the invention extends to cordless, i.e., battery-operated, electric hand tools, in particular of the so-called inline type. The components of the tool receiving unit, the machine housing and a handle, which is usually arranged on it, are oriented along the impact axis in order to efficiently apply the required manual pressure force to a chisel as a tool and to enable the most precise possible handling of the electric hand tool of interest here. The at least one replaceable accumulator unit for the electrical power supply must be arranged on or in the housing so as to be accessible from the outside. However, it is also conceivable to apply the solution according to the invention to other battery-operated electric tools with which an accumulator unit is to be integrated to optimize the installation space. An accumulator unit consists of a housing, usually made of plastic, with electrical contacts in which a plurality of rechargeable battery cells are accommodated and electrically connected to one another. The accumulator unit is a relatively sensitive and safety-relevant component of an electric hand tool. In the event of damage, an exothermic reaction can cause damage in individual cases, which must be taken into account when positioning the accumulator unit relative to the rest of the electric hand tool.

JP 2016 165784 A discloses a generic electric hand tool in inline design. Along the tool axis there is a tool receiving unit, a machine housing for the vibration-damped accommodation of a drive unit and a handle molded onto the rear of the machine housing. In the inner region of the handle, accumulator units are arranged adjacent to one another on the housing end face adjacent to the internal drive unit, in such a way that they do not hinder the functionality of the handle. In this way, the accumulator units are accessible for replacement and, with this placement, do not significantly interfere with the inline design. However, the close proximity to an operator's hand poses a residual risk of injury in the event of a defect.

U.S. Pat. No. 5,208,525 A shows an electrical power supply arrangement for cordless devices, with which a battery unit partially forming the shape of the machine housing is detachably attached to the machine housing. The detachable attachment takes place in the region of the handle, in contrast to the prior art described above, on the outside of the handle. However, with regard to electric hand tools, this prior publication only includes such drilling and sawing tools that are not of the inline type. Rather, the region of the handle in particular protrudes radially from the tool axis, which, in the case of a drilling tool, provides support on the operator side against the machine torque, but at the same time worsens the vibration properties of the electric hand tool.

DE 29 513 651 U1 discloses a battery-powered electric hand tool, in the handle of which a recess for completely accommodating a battery unit is integrated. The accumulator unit is detachably connected to the part of the machine housing that forms the handle by means of catches. The problem with this technical solution is that the installation space in the handle region of a machine housing is limited and only accumulator units with a low energy capacity and correspondingly small dimensions can be accommodated in such region.

### SUMMARY OF THE INVENTION

It is an object of the present invention to further improve a cordless electric hand tool of the generic type, which is specially designed in an inline construction, in such a way that, on the one hand, one or more accumulator units of higher energy capacity, which can be detachably fastened thereto, are arranged so as to be easily exchangeable thereon and, on the other hand, tool handling is improved.

The present invention provides an electric hand tool, in particular an impact hammer, with a tool receiving unit (1) for a tool arranged along an impact axis (X), a drive unit for the tool subsequently accommodated in a machine housing (2) and a handle (3) arranged opposite the tool receiving unit (1) on the machine housing (2), wherein at least one accumulator unit (8a; 8b) detachably fastened to the machine housing (2) is provided for the electrical power supply, characterized in that at least one housing recess (7a; 7b) extending transversely to the impact axis (X) is provided in the region of the machine housing (2) for the exchangeable accommodation of the accumulator unit (8a; 8b), in which the accumulator unit (8a; 8b) is arranged in such a way that the overall center of gravity with respect to the impact axis (X) in the radial direction lies within the lateral dimension of the drive unit.

The invention includes the technical teaching that the machine housing of an electric hand tool of inline design is provided with at least one housing recess extending transversely to the impact axis X for the exchangeable accommodation of the at least one accumulator unit, in which the accumulator unit is arranged in such a way that the overall center of gravity with respect to the impact axis X lies within the lateral dimension of the drive unit.

In other words, the at least one accumulator unit is positioned in the region of the impact axis X within an accuracy range that makes it possible for the overall center of gravity in the radial direction to be no further away from the impact axis X than the geometric dimensions of the drive unit in the radial direction, in particular than the diameter of an impact mechanism if the electric hand tool is designed as an impact hammer.

Advantageously, the weight of the at least one accumulator unit does not significantly change the overall center of gravity in this way. This leads to an improvement in the vibration behavior in all directions and thus in the handling of an electric hand tool designed according to the invention, in particular with regard to simple manual chisel guidance and rotation of the electric hand tool along the impact axis X with minimal effort on the part of the user.

The at least one housing recess for accommodating one or more accumulator units is preferably arranged between the drive unit and the handle inside the machine housing with respect to the impact axis X. This is because sufficient installation space can be created at this point by extending the housing, even for relatively large accumulator units or a plurality of accumulator units. An arrangement of the housing recess between the drive unit and the handle also enables the accumulator unit to be accommodated in a manner that is protected against critical loads. The internal position of the electrical connection contacts also protects them from damage and dirt. In addition, this arrangement of the housing recess in the context of the neighboring structural units enables a minimum internal machine cabling length, which allows higher current flows with smaller cross-sections. This also improves the electromagnetic compatibility of the electric hand tool.

According to a first preferred embodiment, the housing recess is accessible from the lower side and/or the upper side of the machine housing, such that an assigned accumulator unit can be inserted into it from below or from above. According to the invention, the housing of the accumulator unit is dimensioned in relation to the geometric dimensions of the housing recess in such a way that it completely accommodates the accumulator unit in order to achieve the technical advantages described above.

According to a second preferred embodiment, this can also be implemented by arranging the housing recess on one of the flank sides of the machine housing, such that an accumulator unit can be inserted laterally into it. In particular, a left-sided arrangement on the machine housing allows right-handed users who grip the handle of the machine housing with their right hand to mount or remove the accumulator unit with their left hand.

The housing recess according to the invention can optionally also extend continuously through the machine housing, i.e., with regard to the preferred embodiments described above, continuously from top to bottom or extending laterally transversely thereto. The accumulator unit can be mounted or removed from both sides via the recess openings opposite one another, such that the right-handed restriction given as an example above can be eliminated.

However, within the framework of continuous housing recesses, it is also conceivable to insert an accumulator unit from each recess opening, which in this case can even extend beyond the machine housing in the radial direction, since such arrangement creates a compensatory effect with regard to the overall center of gravity.

Preferably, the at least one accumulator unit is arranged with respect to the machine housing in such a way that it can be placed completely within the housing recess, which is located symmetrically with respect to two machine planes A and B arranged at right angles to one another, which coincide on the line of intersection with the impact axis X of the electric hand tool. The machine plane A forms a vertical plane with respect to the electric hand tool, whereas the machine plane B, which is arranged transversely to this, forms a horizontal plane with respect to the electric hand tool in a horizontal holding position of the electric hand tool.

### BRIEF DESCRIPTION OF THE DRAWING

Further measures improving the invention are explained in more detail below together with the description of a preferred exemplary embodiment of the invention with reference to the figures. In the drawings:

FIG. 1 shows a perspective view of an electric hand tool with various options for the arrangement of an accumulator unit thereon, and

FIG. 2 shows a perspective view of the same electric hand tool with an illustration of the position of the machine planes A and B.

### DETAILED DESCRIPTION

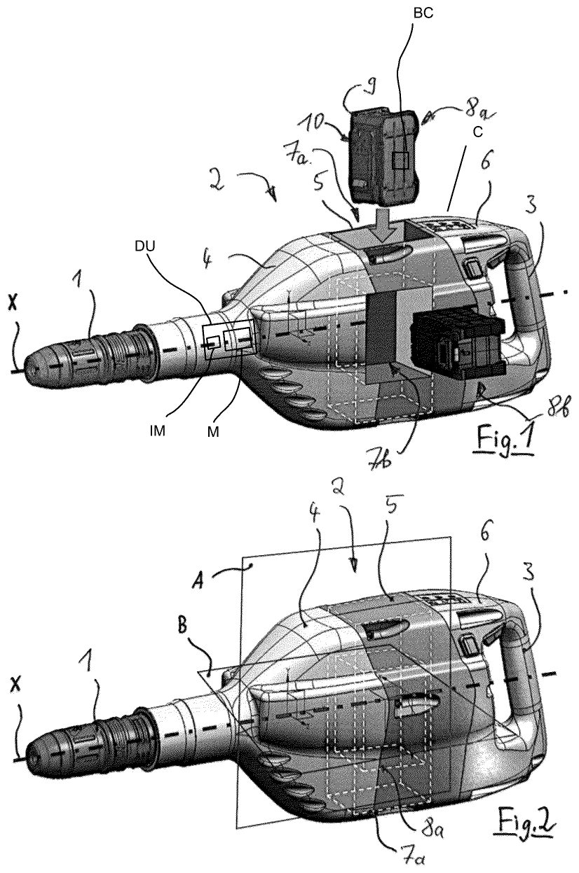

According to FIG. 1, a battery-operated electric hand tool designed as an impact hammer substantially consists of a tool receiving unit 1 arranged along an impact axis X for the detachable attachment of a chisel—not shown further—as a tool and a housing 2 following in the axial direction for accommodating an internal drive unit—shown solely schematically—for the tool. In the case of the impact hammer, the drive unit comprises the familiar combination of an electric motor M with a gearbox and an impact mechanism IM.

Axially opposite the tool receiving unit 1, a handle 3 is arranged on the machine housing 2, which is designed in a manner molded directly onto the machine housing 2.

With this exemplary embodiment, the machine housing 2 is constructed in three parts and consists of a front housing part 4, a middle housing part 5 and a rear housing part 6. While the front housing part 4 is assigned to the tool receiving unit 1, the rear housing part 6 is assigned to the handle 3.

The middle housing part 5 of the machine housing 2 has a vertical housing recess 7a extending transverse to the impact axis X for the exchangeable accommodation of an accumulator unit 8a. The assigned accumulator unit 8a can be arranged in the housing recess 7a in such a way that the overall center of gravity with respect to the impact axis X lies within the lateral dimension of the drive unit. This means that the overall center of gravity of the electric hand tool with respect to the impact axis X does not change outside the lateral dimension of the internal drive unit when the accumulator unit is mounted.

In combination with this exemplary embodiment, an alternative variant is also illustrated, with which the housing recess extends from the flank sides of the machine housing at right angles to the vertical housing recess 7a described above. An accumulator unit 8b can be accommodated in such horizontally extending housing recess 7b and mounted and removed from the side. In contrast, the housing recess 7a is arranged on the lower side and/or the upper side of the machine housing 2.

Both the vertical housing recess 7a and the horizontal housing recess 7b can extend continuously through the machine housing, such that recess openings opposite one another are formed.

The housing recess 7a or 7b arranged in the region of the middle housing part 5 of the machine housing 2 is arranged with respect to the impact axis X between the drive unit adjoining the tool receiving unit 1 on the inside, on the one hand, and the handle 3, on the other hand.

The accumulator unit 8a; 8b in each case has a plastic housing 9 made of a plastic material, on which electrical contacts 10 are located, which are connected inwards to rechargeable battery cells—shown solely schematically as BC—accommodated in the plastic housing 9.

The accumulator unit 8a or 8b can be fastened completely within the assigned housing recess 7a or 7b by means of a clip mechanism C shown solely schematically that can be detached with one hand.

FIG. 2 illustrates the position of the vertical machine plane A and the horizontal machine plane B with respect to the impact axis X. The line of intersection between the two machine planes A and B lies on the impact axis X. In this respect, the continuous housing recess 7a in the middle housing part 5 is positioned symmetrically with respect to both the machine plane A and the machine plane B. The accumulator unit 8a detachably fastened therein is also arranged symmetrically with respect to the assigned housing recess 7a and both machine planes A and B in such a way that the overall center of gravity with respect to the impact axis X in the radial direction lies within the lateral dimension of the internal drive unit according to the invention.

The invention is not limited to the exemplary embodiments described above. On the contrary, modifications thereof are also conceivable, which are encompassed by the scope of protection of the following claims. For example, it is also possible to accommodate more than one accumulator unit within a housing recess as long as the overall center of gravity position with respect to the impact axis X does not exceed the definition according to the invention.

### List of reference signs

1 Tool receiving unit
2 Machine housing
3 Handle
4 Front housing part
5 Middle housing part
6 Rear housing part
7a or 7b Housing recess
8a or 8b Accumulator unit
9 Plastic housing
10 Electrical contact
X Impact axis
A Vertical machine plane
B Horizontal machine plane

1.-10. (canceled)

11. An electric hand tool comprising:
a tool receiver for a tool arranged along an impact axis;
a drive for the tool subsequently accommodated in a machine housing;
a handle arranged opposite the tool receiver on the machine housing;
at least one accumulator unit detachably fastened to the machine housing for electrical power supply,
at least one housing recess extending transversely to the impact axis at the machine housing for exchangeable accommodation of the accumulator unit, the accumulator unit being arranged in such a way that an overall center of gravity with respect to the impact axis in the radial direction lies within a lateral dimension of the drive unit.

12. The electric hand tool as recited in claim 11 wherein the housing recess is arranged on the lower side or the upper side of the machine housing.

13. The electric hand tool as recited in claim 11 wherein the housing recess is arranged on one of the flank sides of the machine housing.

14. The electric hand tool as recited in claim 11 wherein the housing recess extends continuously through the machine housing, such that two recess openings opposite one another are formed.

15. The electric hand tool as recited in claim 11 wherein the housing recess is arranged inside the machine housing with respect to the impact axis between the internal drive unit and the handle.

16. The electric hand tool as recited in claim 11 wherein the impact axis extends on a line of intersection of two machine planes arranged at right angles to one another, wherein the accumulator unit is positioned symmetrically with respect to both machine planes.

17. The electric hand tool as recited in claim 11 wherein the accumulator unit is fastened completely within the housing recess via of a clip mechanism detachable with one hand.

18. The electric hand tool as recited in claim 11 wherein the drive accommodated in the machine housing includes an electric motor with a downstream impact mechanism.

19. The electric hand tool as recited in claim 11 wherein the handle is designed in a manner molded directly onto the machine housing.

20. The electric hand tool as recited in claim 11 wherein the accumulator unit has a plastic housing with at least one rechargeable battery cell accommodated therein.

21. An impact hammer comprising the electric hand tool as recited in claim 11.
